(19) United States
(12) Patent Application Publication
(10) Pub. No.: US 2019/0283289 A1
(43) Pub. Date: Sep. 19, 2019

(54) RESIN SEAL MEMBER AND MOLD OF RESIN SEAL MEMBER

(71) Applicants: Toyota Jidosha Kabushiki Kaisha, Toyota-shi (JP); Toyota Boshoku Kabushiki Kaisha, Kariya-shi (JP)

(72) Inventors: Yoichi Miyagawa, Miyoshi-shi (JP); Tetsuharu Ogawa, Gifu-shi (JP)

(73) Assignees: Toyota Jidosha Kabushiki Kaisha, Toyota-shi (JP); Toyota Boshoku Kabushiki Kaisha, Kariya-shi (JP)

(21) Appl. No.: 16/271,904

(22) Filed: Feb. 11, 2019

(30) Foreign Application Priority Data
Mar. 15, 2018 (JP) 2018-048282

(51) Int. Cl. B29C 44/58

(52) U.S. Cl. CPC B29C 44/585; B29L 2031/26

(57) ABSTRACT

The present disclosure provides a resin seal member capable of reducing the cost while preventing a reduction in the sealing performance due to an influence of heat or pressure in accordance with a usage environment. The present disclosure provides a resin seal member (20) including a foamed resin part (13). This resin seal member (20) includes a convex part (12b) having a foaming ratio lower than that of the foamed resin part (13). The convex part (12b) is provided in an end part of the foamed resin part (13). The resin seal member (20) is able to reduce the cost while preventing the reduction in the sealing performance due to the influence of heat or pressure in accordance with the usage environment.

### CROSS REFERENCE TO RELATED APPLICATIONS

This application is based upon and claims the benefit of priority from Japanese patent application No. 2018-048282, filed on Mar. 15, 2018, the disclosure of which is incorporated herein in its entirety by reference.

### BACKGROUND

The present disclosure relates to a resin seal member and a mold of a resin seal member.

Japanese Unexamined Patent Application Publication No. 2002-168505 discloses a foaming molded body including a foaming molded main body and a convex part provided on the foaming molded main body. The foaming molded main body and the convex part are integrally foam molded. This foaming molded body functions as a seal member.

### SUMMARY

The present inventors have found the following problem.

When the aforementioned foaming molded body receives heat or pressure in accordance with a usage environment, it may be plastically deformed, which may cause a decrease in the sealing performance.

The present inventors have conceived of using a convex body having a shape the same as that of the convex part, the convex body being molded without being foamed, as a seal member. However, since this convex body has a density higher than that of the convex part that has been foam molded, the cost of the materials tends to increase.

The present disclosure provides a resin seal member capable of reducing the cost while preventing a reduction in the sealing performance due to an influence of heat or pressure in accordance with the usage environment.

A resin seal member according to the present disclosure is a resin seal member including a foamed resin part, including a convex part having a foaming ratio lower than that of the foamed resin part, in which the convex part is provided in an end part of the foamed resin part.

According to this structure, the convex part is less likely to be plastically deformed than the foamed resin part. Since the convex part is provided in the end part of the foamed resin part, even when the foamed resin part is plastically deformed, a change in the shape of the convex part is prevented and the sealing performance is secured. Even under the influence of heat or pressure in accordance with the usage environment, a reduction in the sealing performance is prevented. Further, the cost of the materials of the resin seal member is lower than the cost of the materials of the aforementioned convex body that is molded without being foamed. Therefore, with the use of the resin seal member, it is possible to reduce the cost.

Further, the foamed resin part may be attached onto an element, the element may be made of a material having a composition different from that of a foamed resin material that composes the foamed resin part, the element may include an element convex part having a shape the same as that of the convex part, and the element convex part may enter the foamed resin part.

According to this structure, the contact area of the foamed resin part with the element is increased. Therefore, even when the composition of the material of the foamed resin part and that of the element are different from each other, the foamed resin part and the element are adhered to each other with a high adhesive strength.

Further, a mold of a resin seal member according to the present disclosure is a mold of a resin seal member including a resin base material molding die part for molding a resin base material, including:

a sliding part capable of sliding in a foamed resin part molding cavity that communicates with a resin base material molding cavity of the resin base material molding die part, in which

a recessed part is provided on a distal end surface of the sliding part on a side of the resin base material molding cavity,

in the process of molding the resin base material, the sliding part blocks an opening part that communicates from the resin base material molding cavity to the foamed resin part molding cavity, and

in the process of molding the foamed resin part, after a foamed resin material is filled into the foamed resin part molding cavity, the sliding part is separated from the resin base material molding cavity, thereby increasing a filling space that can be filled with the foamed resin material.

According to this structure, it is possible to integrally mold the aforementioned resin seal member and the resin base material, which is used as the element, easily.

According to the present disclosure, it is possible to provide a resin seal member capable of reducing the cost while preventing a reduction in the sealing performance due to an influence of heat or pressure in accordance with the usage environment.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing a usage example of a resin seal member according to a first embodiment;

FIG. 2 is a schematic cross-sectional view of the resin seal member and some of elements according to the first embodiment;

FIG. 3 is a schematic cross-sectional view showing a method of using the resin seal member according to the first embodiment;

FIG. 4 is a schematic cross-sectional view of a mold of a resin seal member according to the first embodiment;

FIG. 5 is a schematic cross-sectional view of a distal end of a sliding part 3 of a movable die 2 of a resin seal member according to the first embodiment;

FIG. 6 is a schematic view showing one process of a method of manufacturing the resin body according to the first embodiment;

FIG. 7 is a schematic enlarged view showing one process of the method of manufacturing the resin body according to the first embodiment;

FIG. 8 is a schematic view showing one process of the method of manufacturing the resin body according to the first embodiment;

FIG. 9 is a schematic enlarged view showing one process of the method of manufacturing the resin body according to the first embodiment;

FIG. 10 is a schematic view showing one process of the method of manufacturing the resin body according to the first embodiment;

FIG. 11 is a schematic enlarged view showing one process of the method of manufacturing the resin body according to the first embodiment;

FIG. 12 is a schematic view showing one process of the method of manufacturing the resin body according to the first embodiment; and

FIG. 13 is a schematic enlarged view showing one process of the method of manufacturing the resin body according to the first embodiment.

### DESCRIPTION OF EMBODIMENTS

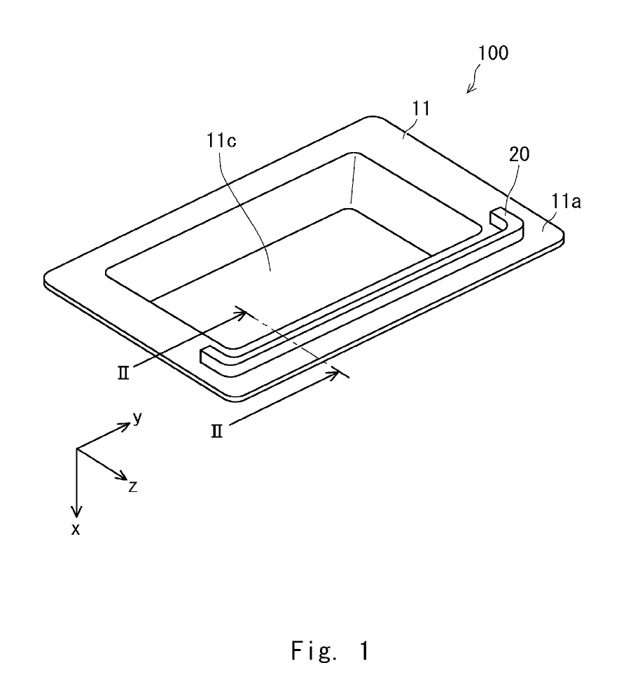

The specific embodiment to which the invention is applied will be described hereinafter in detail with reference to the drawings. It should be noted, however, that the invention is not limited to the following embodiment. Besides, the following description and drawings are simplified as appropriate for the sake of clarification of explanation. In FIGS. 1-13, a right-handed three-dimensional xyz orthogonal coordinate system is specified. Incidentally, as a matter of course, the right-handed xyz-coordinate system shown in FIG. 1 and the other drawings is used for the sake of convenience to illustrate a positional relationship among components. In general, as is common among the drawings, a positive direction along a z-axis is a vertically upward direction, and an xy-plane is a horizontal plane.

### First Embodiment

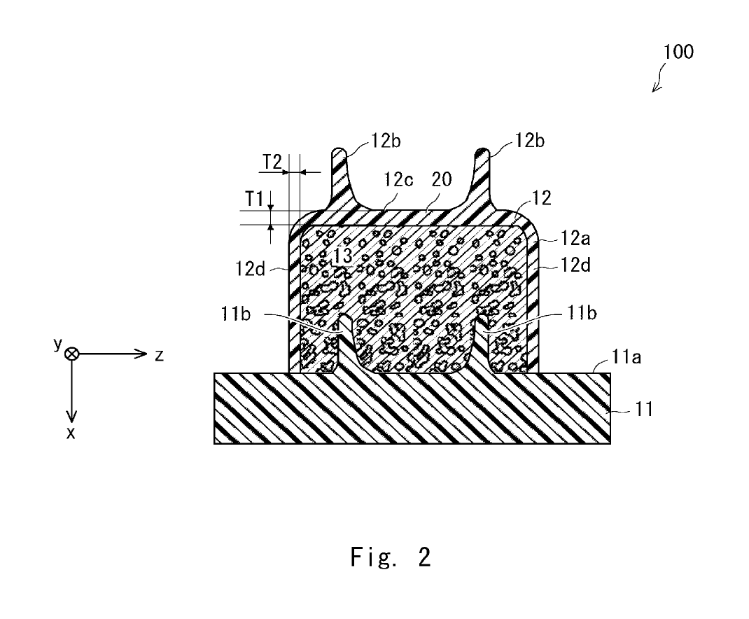

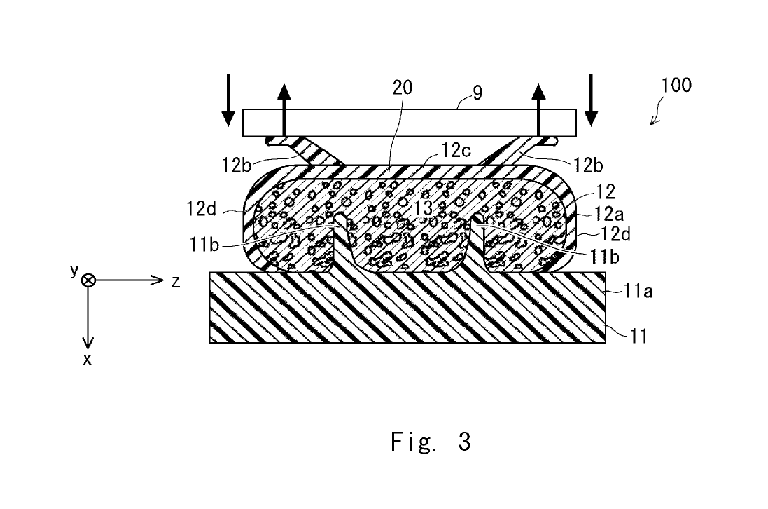

With reference to FIGS. 1-3, a resin seal member according to a first embodiment will be explained. FIG. 1 is a perspective view showing a usage example of the resin seal member according to the first embodiment. FIG. 2 is a schematic cross-sectional view of the resin seal member and some of elements according to the first embodiment. FIG. 3 is a schematic cross-sectional view showing a method of using the resin seal member according to the first embodiment. In FIGS. 2 and 3, the hatching of a resin base material 11 and a surface skin part 12 is omitted for the sake of clarity.

While a resin seal member 20 may have a large variety of shapes, it has, for example, a string shape, as shown in FIG. 1. The resin seal member 20 can be attached to, for example, the resin base material 11 shown in FIG. 1 to be used. The resin base material 11 is a dish-shaped body including a recessed part 11c that is concaved in a rectangular parallelepiped shape. One example of the resin seal member 20 shown in FIG. 1 is arranged in the vicinity of a plate-shaped part 11a provided on the outer periphery of the recessed part 11c of the resin base material 11, is extended along one side of the recessed part 11c, and is extended so as to surround both end parts of one side of the recessed part 11c. The resin seal member 20 and the resin base material 11 are used as a resin body 100.

A large variety of resins may be used for the resin base material 11. A resin that can be foamed may be used for the resin seal member 20. This resin that can be foamed includes, for example, thermoplastic elastomer. Specific examples include saturated styrene elastomer, polyolefin, or a compound thereof, or ethylene-propylene rubber, ethylene propylene diene rubber or the like. A foaming agent may be anything that is capable of foam molding elastomer by injection molding, and may be, for example, sodium bicarbonate or azo compounds.

As shown in FIG. 2, the resin seal member 20 includes a surface skin part 12 and a foamed resin part 13. The resin base material 11 includes a plate-shaped part 11a and a base material convex part 11b. The base material convex part 11b is provided between the resin base material 11 and the foamed resin part 13, is protruded from the plate-shaped part 11a to the foamed resin part 13, and enters the foamed resin part 13.

The foamed resin part 13 is arranged on the surface of the resin base material 11. The surface skin part 12 covers the surface of the foamed resin part 13. The surface skin part 12 is preferably made of a material the same as that of the foamed resin part 13, and is preferably formed by integral molding. The surface skin part 12 has a foaming ratio lower than that of the foamed resin part 13. The foaming ratio is preferably obtained using a known method, and may be obtained, for example, from the apparent density and the density before foaming.

The surface skin part 12 includes a surface skin body 12a and a convex part 12b. The surface skin body 12a includes a surface skin upper part 12c and a surface skin side part 12d. The surface skin upper part 12c covers the surface of the foamed resin part 13 on the side opposite to the resin base material 11 (in this example, the x-axis negative side). The surface skin side part 12d covers the surface of the side part of the foamed resin part 13. The surface skin upper part 12c communicates with the surface skin side part 12d. The thickness T1 of the surface skin upper part 12c is preferably larger than the thickness T2 of the surface skin side part 12d. The convex part 12b is provided in the surface skin upper part 12c. Specifically, the convex part 12b is provided in the end part of the surface skin upper part 12c on the opposite side (in this example, the x-axis negative side) of the resin base material 11. The convex part 12b is protruded from the surface skin upper part 12c to a side opposite to the resin base material 11.

The foaming ratio of the foamed resin part 13 is higher than the foaming ratio of the surface skin part 12. The foamed resin part 13 is less rigid than the surface skin part 12 and has a high cushioning performance. On the other hand, the surface skin part 12 is more rigid than the foamed resin part 13 and has a high sealing performance. The resin body 100 is preferably used as each element mounted on a vehicle, and is preferable, in particular, as an element requiring a sealing performance and a cushioning performance.

### (Usage)

Next, a method of using the resin seal member 20 will be explained.

As shown in FIG. 3, a sealed element 9 is pressed against the resin seal member 20 in the resin base material 11. Then the resin seal member 20 is held between the sealed element 9 and the resin base material 11, and the surface skin part 12 receives pressure from the sealed element 9 and the resin base material 11. The surface skin part 12 is more rigid than the foamed resin part 13. Further, the convex part 12b of the surface skin part 12 is provided in the end part of the surface skin upper part 12c on the opposite side (in this example, the x-axis negative side) of the resin base material 11. Therefore, the convex part 12b repels the sealed element 9, and thus there is no gap between the convex part 12b and the sealed element 9. That is, the resin seal member 20 is able to seal the sealed element 9 and the resin base material 11.

Further, even when the resin seal member 20 is used in a usage environment in which it is susceptible to heat or pressure and the foamed resin part 13 is therefore plastically deformed, the shape of the convex part 12b is less changed compared to the change in the shape of the foamed resin part 13. Therefore, since the convex part 12b strongly repels the sealed element 9, the sealing performance of the resin seal member 20 is secured. That is, even under the influence of heat or pressure in accordance with the usage environment, it is possible to prevent a reduction in the sealing performance of the resin seal member 20.

Further, the density of the resin seal member 20 is lower than that of the convex body molded without being foamed, and the amount of materials that are being used is small. Therefore, with the use of the resin seal member 20, the cost can be reduced.

Further, there is a case in which the thickness T1 of the surface skin upper part 12c is larger than the thickness T2 of the surface skin side part 12d. In this case, the high sealing performance and the high cushioning performance of the resin seal member 20 can be substantially maintained while stably supporting the convex part 12b by the surface skin upper part 12c and reducing the amount of materials forming the surface skin side part 12d. That is, it is possible to properly place the amount of materials that are being used in each structure, and to further reduce the cost.

### (Mold)

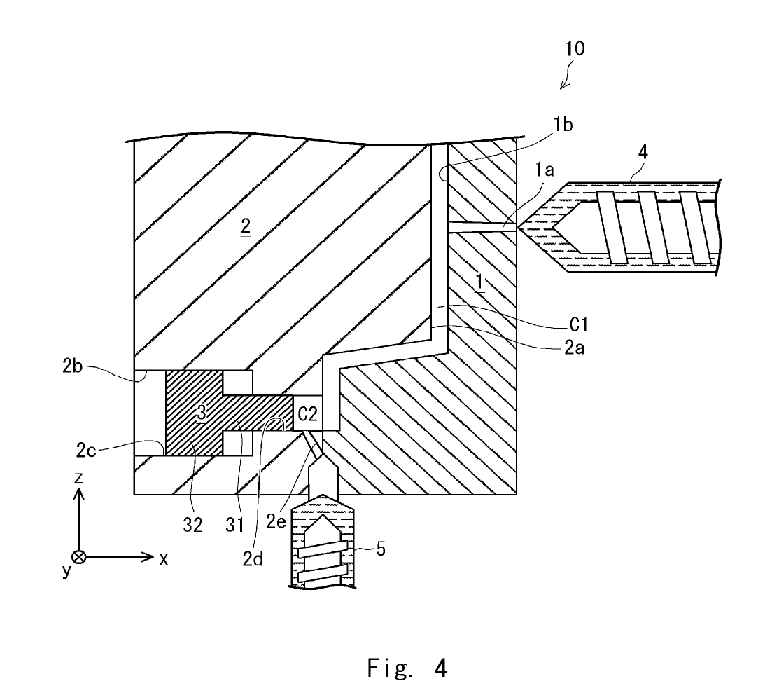

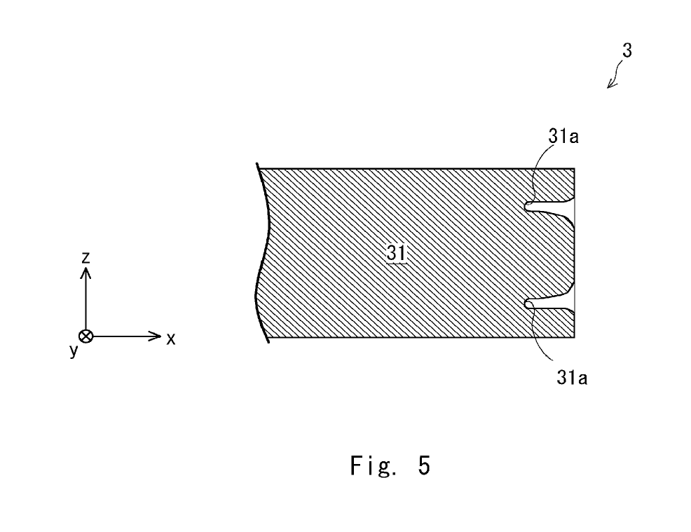

With reference next to FIGS. 4 and 5, a mold of the resin seal member according to the first embodiment will be explained. FIG. 4 is a schematic cross-sectional view of the mold of the resin seal member according to the first embodiment. FIG. 5 is a schematic cross-sectional view of the distal end of the sliding part 3 of the movable die 2 of the resin seal member according to the first embodiment.

As shown in FIG. 4, a mold 10 includes a fixed die 1 and a movable die 2. The fixed die 1 and the movable die 2 may each be referred to as a resin base material molding die part. The mold 10 can be used along with an injection molding machine and the like in order to mold the resin seal member.

The fixed die 1 is held at a predetermined position by an injection molding machine or the like. The fixed die 1 includes an inflow hole 1a and a resin base material molding surface 1b. A molten resin can be made to flow into the inflow hole 1a from a resin base material molding injection nozzle 4. The resin base material molding surface 1b is continuous with the inner wall surface of the inflow hole 1a.

The movable die 2 is held by an injection molding machine or the like in such a way that the movable die 2 can be pressed against or separated from the fixed die 1. The movable die 2 includes a resin base material molding surface 2a and a sliding part holding hole 2b. The sliding part holding hole 2b includes holes 2c and 2d that slidably hold the sliding part 3. The hole 2d communicates with the hole 2c. The hole 2c is preferably thicker than the hole 2d. The hole 2c preferably has a cross-sectional area lager than that of the hole 2d.

When the movable die 2 is pressed against the fixed die 1, a resin base material molding cavity C1 is formed between the resin base material molding surface 2a and the resin base material molding surface 1b. Further, when the distal end of the sliding part 3 is separated from the fixed die 1 while the movable die 2 is kept to be pressed against the fixed die 1, a foamed resin part molding cavity C2 is formed in the hole 2d. The foamed resin part molding cavity C2 communicates with the resin base material molding cavity C1. The molten resin is made to flow into the foamed resin part molding cavity C2 from a foamed resin part molding injection nozzle 5 through an inflow hole 2e.

The sliding part 3 includes a core 31 and a core holder 32. The core 31 has a shape that is protruded from the core holder 32. The sliding part 3 is preferably provided with technical means for applying a force to the sliding part 3 from the side of the core holder 32 in such a way that the sliding part 3 approaches or is separated from the hole 2d in the sliding direction of the sliding part 3. This technical means may be a large variety of mechanisms and devices such as a motor, a hydraulic cylinder, and a cam mechanism. The sliding part 3 is slid in the holes 2c and 2d by this technical means. Since the core holder 32 tends to be thicker than the core 31, the sliding part 3 can stably slide by applying a force to the sliding part 3 from the side of the core holder 32.

As shown in FIG. 5, the core 31 includes a recessed part 31a, which is provided on the distal end surface of the core 31 on the side of the resin base material molding cavity C1 (in this example, the x-axis direction positive side). The shape of the recessed part 31a is not limited to the shape shown in FIG. 5, and may be a wide variety of shapes. Further, only one recessed part 31a may be provided or a plurality of recessed parts 31a may be provided.

### (Manufacturing Method)

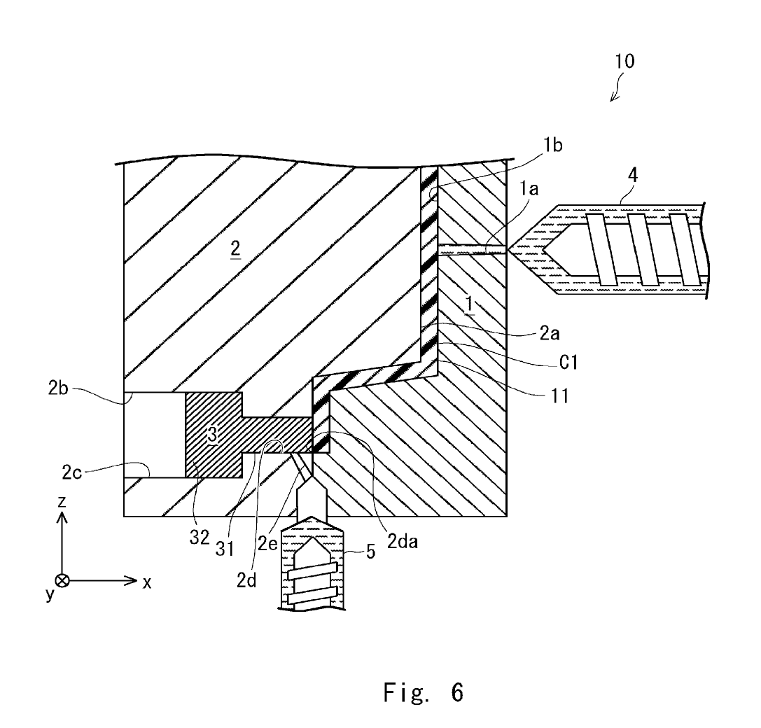

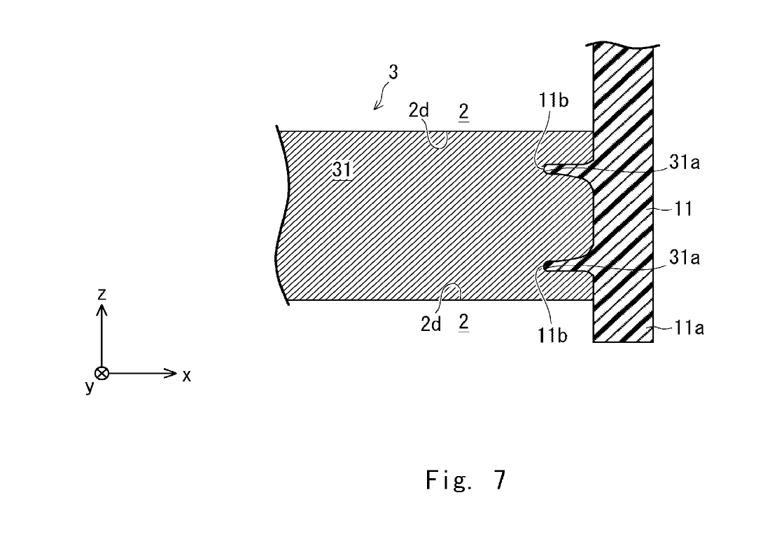

With reference next to FIGS. 6-13, a method of manufacturing the resin seal member according to the first embodiment will be explained. FIGS. 6, 8, 10, and 12 are schematic views each showing one process of the method of manufacturing the resin body according to the first embodiment. FIGS. 7, 9, 11, and 13 are schematic enlarged views each showing one process of the method of manufacturing the resin body according to the first embodiment. In FIGS. 7, 9, 11, and 13, the hatching of the movable die 2 is omitted for the sake of clarity.

As shown in FIG. 6, the resin material is filled into the resin base material molding cavity C1 from the resin base material molding injection nozzle 4, thereby forming the resin base material 11 (resin base material forming process ST1).

Specifically, first, while pressing the movable die 2 against the fixed die 1, the tip of the core 31 of the sliding part 3 is positioned at the distal end of the hole 2d on the side of the resin base material molding cavity C1 (in this example, the x-axis direction positive side). Accordingly, an opening part 2da that communicates from the resin base material molding cavity C1 to the foamed resin part molding cavity C2 is interrupted.

Further, the resin material is injected from the resin base material molding injection nozzle 4, passes the inflow hole 1a of the fixed die 1, and is filled into the resin base material molding cavity C1. Since the opening part 2da is interrupted, the resin material rarely enters the foamed resin part molding cavity C2. After the filling process, the resin material is solidified in the resin base material molding cavity C1, whereby the resin base material 11 is formed.

As shown in FIG. 7, the resin base material 11 includes the plate-shaped part 11a and the base material convex part 11b protruding from the plate-shaped part 11a. The base material convex part 11b has a shape in which the shape of the recessed part 31a is transferred.

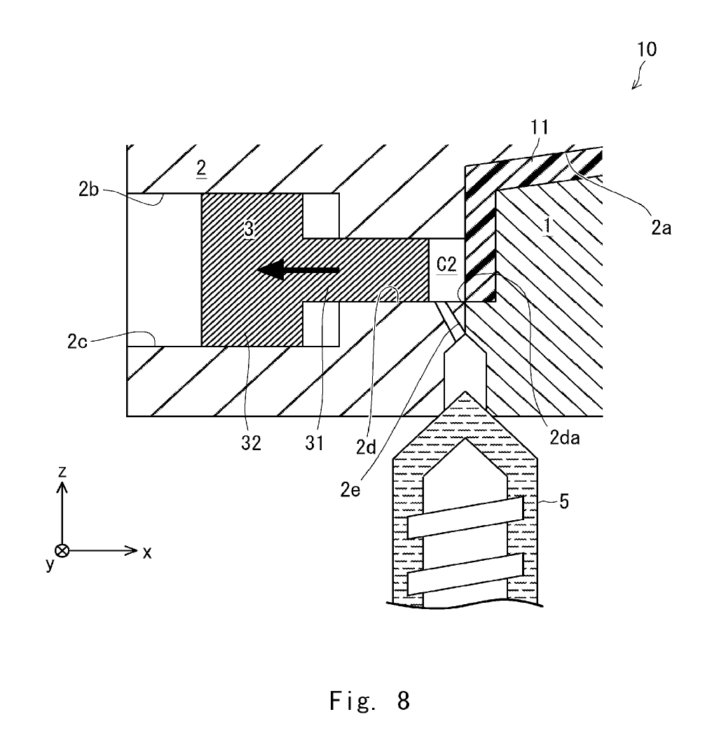

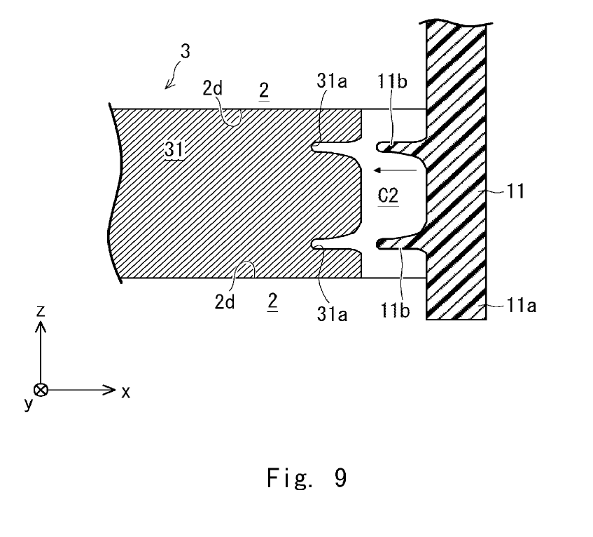

Next, as shown in FIGS. 8 and 9, the sliding part 3 is separated from the resin base material molding cavity C1 (sliding part retracting process ST2). In the foamed resin part molding cavity C2, the filling space that can be filled with the foamed resin material is increased.

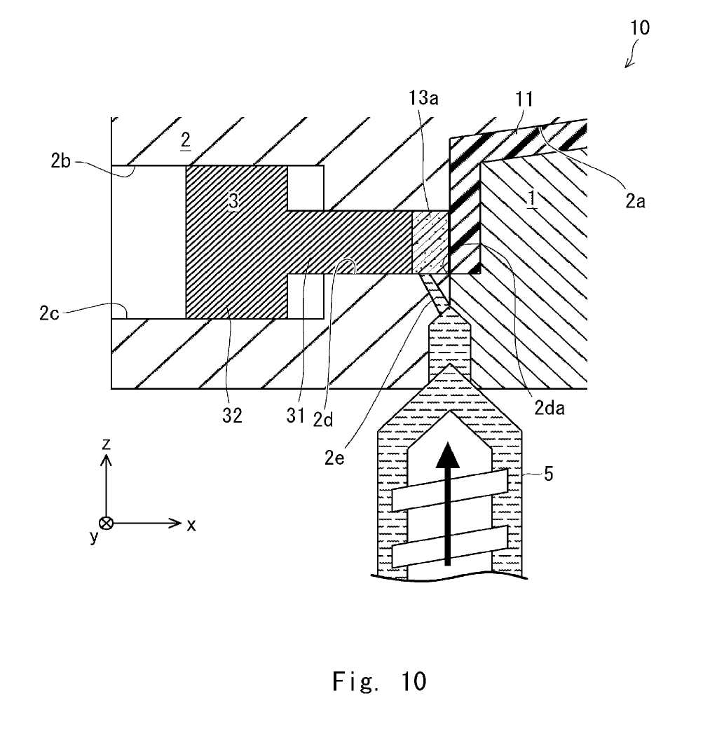

Next, as shown in FIG. 10, a foamed resin material 13a is filled into the foamed resin part molding cavity C2 from the foamed resin part molding injection nozzle 5 via the inflow hole 2e (foamed resin filling process ST3).

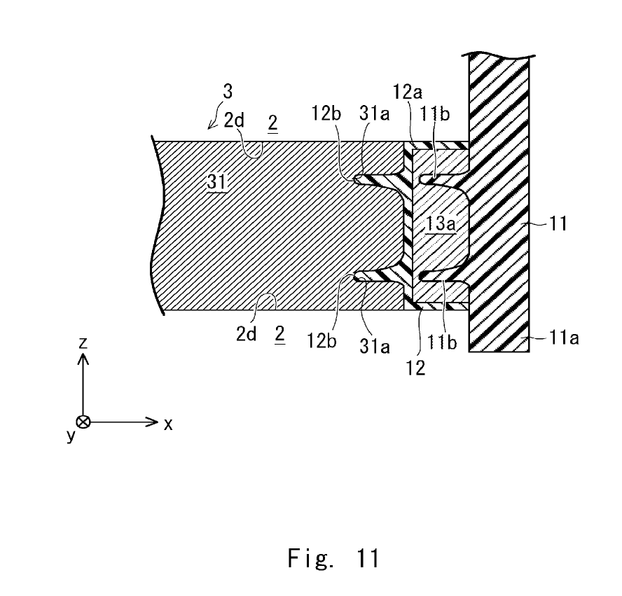

Then, as shown in FIG. 11, after the foamed resin material 13a is made to flow into the recessed part 31a, the foamed resin material 13a in the vicinity of the interface with the core 31 is solidified while it is not at least foamed completely, whereby the surface skin part 12 is formed. The surface skin part 12 includes the surface skin body 12a and the convex part 12b protruded from the surface skin body 12a. The surface skin body 12a covers the foamed resin material 13a that has not yet been solidified, and the convex part 12b has a shape transferred to the recessed part 31a. Since the core 31 of the sliding part 3 includes the recessed part 31a, the contact area of the surface skin part 12 with the core 31 is large.

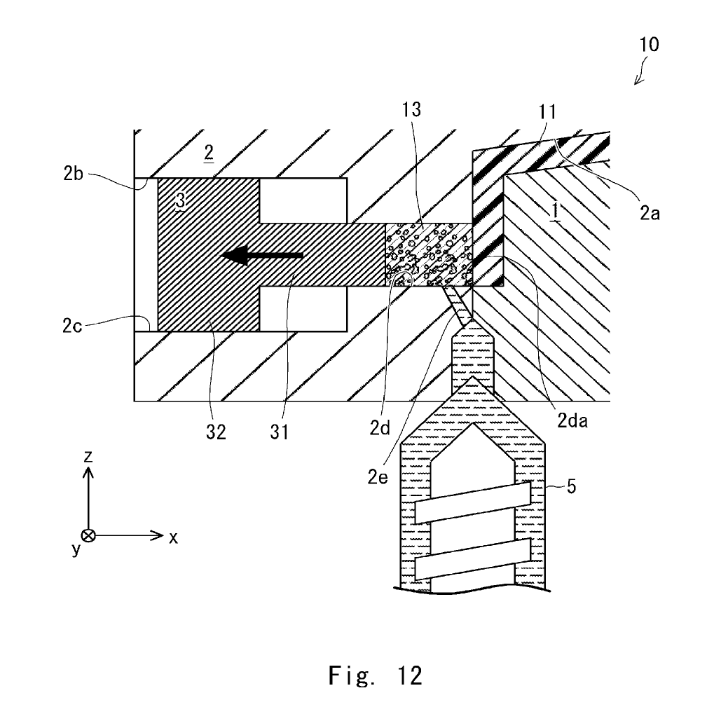

Lastly, as shown in FIG. 12, by foaming the foamed resin material 13a, the foamed resin part 13 is formed in the resin base material 11 (foaming process ST4).

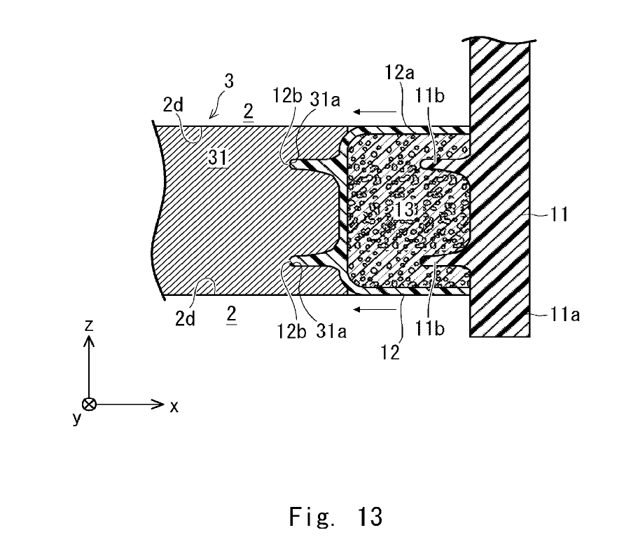

Specifically, as shown in FIG. 13, by foaming the foamed resin material 13a, the foamed resin part 13 is formed. The sliding part 3 (see FIG. 9) is preferably separated from the resin base material molding cavity C1 as appropriate. Due to the spacing of the sliding part 3, the surface skin side part 12d tends to receive a tensile stress larger than that the surface skin upper part 12c receives. Therefore, the thickness T1 of the surface skin upper part 12c tends to be larger than the thickness T2 of the surface skin side part 12d. Further, the foamed resin part 13 is foamed and the foaming ratio of the foamed resin part 13 is made higher than that of the surface skin part 12.

From the aforementioned processes, the resin body 100 shown in FIG. 1 can be formed. Accordingly, the resin body 100 in which the resin base material 11 and the resin seal member 20 are bonded to each other can be integrally molded easily.

Further, the core 31 of the sliding part 3 includes the recessed part 31a. Therefore, when the foamed resin material 13a is filled into the foamed resin part molding cavity C2 in the foaming process ST4, the contact area between the surface skin part 12 and the core 31 of the sliding part 3 is large. The surface skin part 12 is one structure of the resin seal member 20. That is, the contact area between the resin seal member 20 and the sliding part 3 can be increased. Accordingly, it is possible to prevent the resin seal member 20 from being separated from the sliding part 3, whereby it is possible to mold the resin seal member 20 with a high precision.

Note that the present disclosure is not limited to the aforementioned embodiment and may be changed as appropriate without departing from the spirit of the present disclosure. For example, while the resin seal member 20 is used while it is attached to the resin base material 11 shown in FIG. 1 in the first embodiment, the resin seal member 20 may be attached to an element made of a material having a composition different from that of the material that composes the resin seal member 20. This element preferably has an element convex part having a shape the same as that of the base material convex part 11b of the resin seal member 20.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A resin seal member comprising a foamed resin part,
comprising a convex part having a foaming ratio lower than that of the foamed resin part,
wherein the convex part is provided in an end part of the foamed resin part.

2. The resin seal member according to claim 1, wherein
the foamed resin part is attached onto an element,
the element is made of a material having a composition different from that of a foamed resin material that composes the foamed resin part,
the element comprises an element convex part having a shape the same as that of the convex part, and
the element convex part enters the foamed resin part.

3. A mold of a resin seal member comprising a resin base material molding die part for molding a resin base material, comprising:
a sliding part capable of sliding in a foamed resin part molding cavity that communicates with a resin base material molding cavity of the resin base material molding die part, wherein
a recessed part is provided on a distal end surface of the sliding part on a side of the resin base material molding cavity,
in the process of molding the resin base material, the sliding part blocks an opening part that communicates from the resin base material molding cavity to the foamed resin part molding cavity, and
in the process of molding the foamed resin part, after a foamed resin material is filled into the foamed resin part molding cavity, the sliding part is separated from the resin base material molding cavity, thereby increasing a filling space that can be filled with the foamed resin material.
